(19) United States
(12) Patent Application Publication
(10) Pub. No.: US 2008/0241017 A1
(43) Pub. Date: Oct. 2, 2008

(54) ELECTRONIC DEVICE

(75) Inventors: Chiu-Yuan Lin, Taipei (TW); Hsiu-Fen Yeh, Taipei (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: BEYOND INNOVATION TECHNOLOGY CO., LTD., Taipei (TW)

(21) Appl. No.: 11/945,321

(22) Filed: Nov. 27, 2007

(30) Foreign Application Priority Data
Mar. 26, 2007 (TW) 96110357

(51) Int. Cl. B01J 19/08; B01D 35/00; B01J 19/00

(52) U.S. Cl. 422/186.12; 55/385.1; 96/417; 422/186.04; 422/211

(57) ABSTRACT

An electronic device including a control module and a filter. The electronic device generates a pernicious substance when the electronic device is operated. The control module controls the electronic device. The filter filters the pernicious substance.

### BACKGROUND OF THE INVENTION

1. Field of the Invention

The invention relates to an electronic device, and more particularly to an electronic device for eliminating a pernicious substance generated by the electronic device.

2. Description of the Related Art

With technology development, more electronic products are invented. The electronic products comprise electronic devices, electric machinery devices and photoelectric devices. When one electronic product is operated, various pernicious substances, such as toxic substances, foul gas, or positive ion, are generated due to temperature or high voltage. If the pernicious substances are inhaled by a person, the person feels uncomfortable. Taking a computer as an example, when the computer is operated, positive ions are continuously generated by a monitor. Since the monitor is normally close to the user, positive ions are inhaled by the user.

Additionally, when a vehicle is operated, pernicious substances are generated by an engine of the vehicle. A chemical reaction is caused when the pernicious substances touch water. Thus, the driver may feel eye or lung discomfort, due to a nitrous acid generated by the chemical reaction.

### BRIEF SUMMARY OF THE INVENTION

Electronic devices are provided. An exemplary embodiment of an electronic device comprises a control module and a filter. The electronic device generates a pernicious substance when the electronic device is operated. The control module controls the electronic device. The filter filters the pernicious substance.

A detailed description is given in the following embodiments with reference to the accompanying drawings.

### BRIEF DESCRIPTION OF THE DRAWINGS

The invention can be more fully understood by referring to the following detailed description and examples with references made to the accompanying drawings, wherein:

FIG. 1 is a schematic diagram of an exemplary embodiment of an electronic device;

FIG. 2 is a schematic diagram of an exemplary embodiment of a filter;

FIG. 3 is a schematic diagram of another exemplary embodiment of the filter; and

FIG. 4 is a schematic diagram of another exemplary embodiment of the electronic device.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

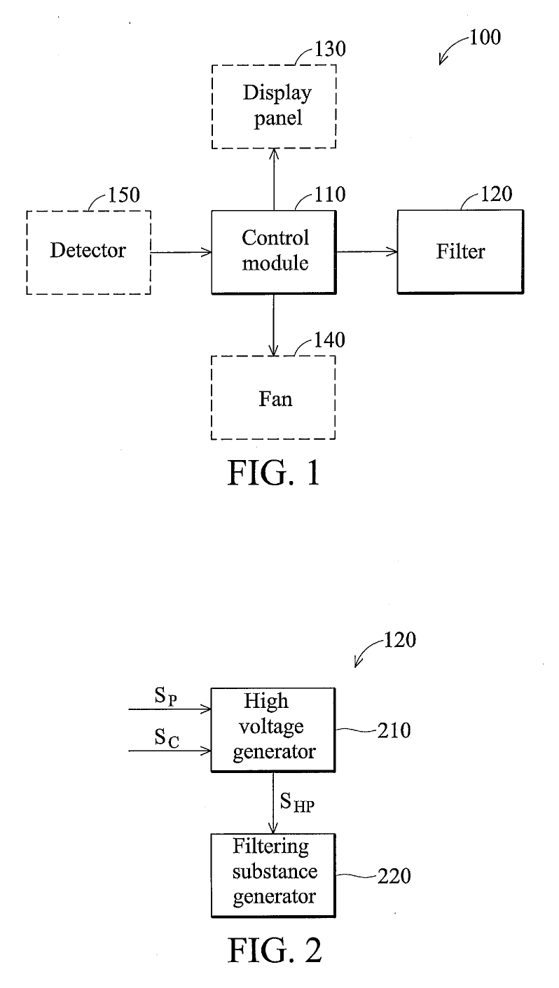

FIG. 1 is a schematic diagram of an exemplary embodiment of an electronic device. The electronic device 100 comprises a control module 110 and a filter 120. When the electronic device 100 is operated, a pernicious substance is generated. The pernicious substance is eliminated by the filter 120.

In one embodiment, the electronic device 100 further comprises a display panel 130, a fan 140, and a detector 150. In another embodiment, the electronic device 100 comprises one of the display panel 130, the fan 140, and the detector 150 or comprises two of the display panel 130, the fan 140, and the detector 150.

The display panel 130 is controlled by the control module 110. In this embodiment, the control module 110 is a micro-controller. The display panel 130 is capable of displaying dynamic images. For example, the display panel 130 is a panel of a television, a monitor, or a portable product, wherein the portable product can be a 3G cell phone or a PDA. When the electronic device 100 is operated, the display panel 130 generates a large amount of positive ions. The positive ions can be eliminated by the filter 120.

The rotational speed of the fan 140 is controlled by the control module 110. In one embodiment, the fan 140 and the control module 110 are simultaneously turned on. The control module 110 dynamically adjusts the rotational speed of the fan 140 according to the concentration of the pernicious substance. When the fan 140 is operated, the pernicious substance is blown away or the filtering range of the filter 120 is increased. When the concentration of the pernicious substance is less than a preset value, the control module 110 stops activating the fan 140 to avoid excess power consumption. In other embodiments, the fan 140 is replaced by other wind loops.

The detector 150 detects the concentration of the pernicious substance and provides the detection result to the control module 110. The control module 110 resiliently adjusts the filtering strength of the filter 120 according to the concentration of the pernicious substance. Thus, the pernicious substance is effectively eliminated. In some embodiments, the detector 150 directly provides the detection result to the filter 120.

FIG. 2 is a schematic diagram of an exemplary embodiment of a filter. The filter 120 comprises a high voltage generator 210 and a filtering substance generator 220. The high voltage generator 210 transforms an input voltage S_{P} into a high voltage signal S_{HP} according to a control signal S_{C} generated by the control module 110.

In this embodiment, filtering substance generator 220 is an ozone generator. The ozone generator generates ozone according to the high voltage signal S_{HP}. When the concentration of the ozone is higher, the ozone can sterilize the air. When the concentration of the ozone is lower, the ozone freshen the air. The control signal S_{C} is generated by the control module 110 for activating or de-activating the filter 120 every a constant time.

Additionally, the control module 110 determines the concentration of the ozone according to the concentration of the pernicious substance. When the concentration of the pernicious substance is less than a preset value, the filter 120 is de-activated to save power. In some embodiments, the filtering substance generator 220 is a negative ion generator for generating negative ions. The negative ion generator is capable of counteracting the pernicious substance, such as positive ions. When the negative ion generator receives the high voltage signal S_{HP}, negative ions are generated for eliminating foul gas and the pernicious substance.

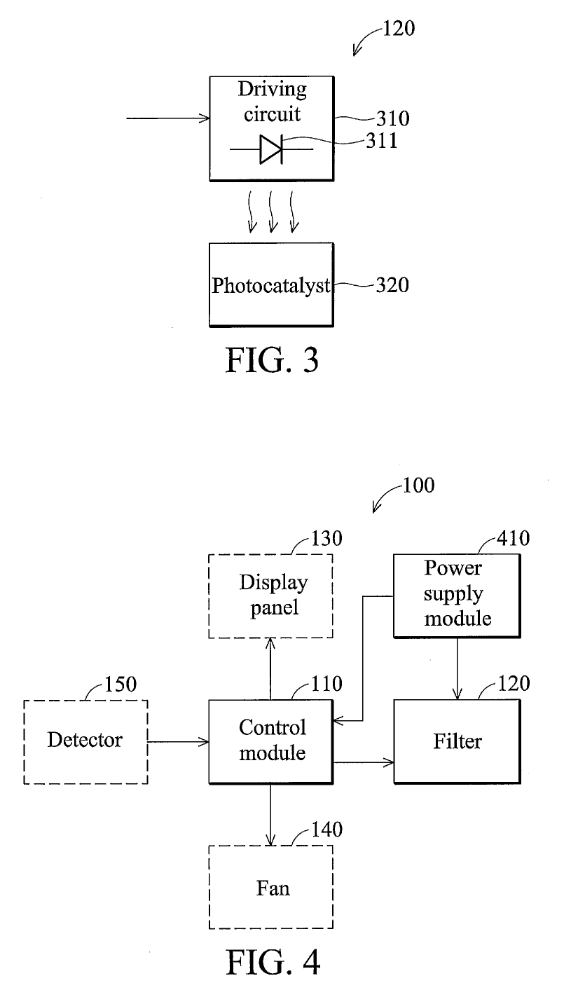

FIG. 3 is a schematic diagram of another exemplary embodiment of the filter. The filter 120 comprises a driving circuit 310 and a photocatalyst 320. The driving circuit 310 drives the photocatalyst 320 for eliminating the pernicious substance generated by the electronic device 110. In this embodiment, the driving circuit 310 comprises a light emitting diode (LED) 311 for emitting ultraviolet rays. When the ultraviolet rays irradiate the photocatalyst 320, the photocatalyst 320 is activated for eliminating the pernicious substance.

FIG. 4 is a schematic diagram of another exemplary embodiment of the electronic device. FIG. 4 is similar to FIG. 1 with the exception that a power supply module 410 is added. The power supply module 410 provides power, such as the input voltage S_{P}, to the control module 110 and the filter 120. Since the control module 110 and the filter 120 utilize the same power supply module, the cost of elements is reduced and usable space is increased.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An electronic device generating a pernicious substance when the electronic device is operated, comprising:
a control module controlling the electronic device; and
a filter filtering the pernicious substance.

2. The electronic device as claimed in claim 1, further comprising a display panel controlled by the control module, wherein the display panel is capable of displaying dynamic images.

3. The electronic device as claimed in claim 1, further comprising a fan.

4. The electronic device as claimed in claim 1, further comprising a detector, wherein the filter is activated by the detector when the concentration of the pernicious substance reaches a preset value.

5. The electronic device as claimed in claim 1, wherein the filter comprises:
a high voltage generator providing a high voltage signal according to a control signal; and
a filtering substance generator generating a filtering substance according to the high voltage signal, wherein the pernicious substance is filtered by the filtering substance.

6. The electronic device as claimed in claim 5, wherein the control module is capable of activating or de-activating the filter every a constant time.

7. The electronic device as claimed in claim 5, wherein the filtering substance generator is an ozone generator.

8. The electronic device as claimed in claim 7, wherein the control module generates the control signal for controlling the concentration of the pernicious substance.

9. The electronic device as claimed in claim 5, wherein the filtering substance generator is a negative ion generator.

10. The electronic device as claimed in claim 1, wherein the filter comprises:
a photocatalyst eliminating the pernicious substance; and
a driving circuit driving the photocatalyst.

11. The electronic device as claimed in claim 10, wherein the driving circuit comprises a light emitting diode (LED).

12. The electronic device as claimed in claim 11, wherein the LED emits ultraviolet rays.

13. The electronic device as claimed in claim 1, further comprising a power supply providing a power to the control module and the filter.
